(19) United States
(12) Patent Application Publication
(10) Pub. No.: US 2026/0348444 A1
(43) Pub. Date: Nov. 5, 2026

(54) ARCHITECTURED LATTICE STRUCTURE

(71) Applicant: COMMISSARIAT A L'ENERGIE ATOMIQUE ET AUX ENERGIES ALTERNATIVES, Paris (FR)

(72) Inventors: Michaël BOUVIER, Grenoble cedex 09 (FR); Hervé GLEYZES, Grenoble cedex 09 (FR)

(73) Assignee: COMMISSARIAT A L'ENERGIE ATOMIQUE ET AUX ENERGIES ALTERNATIVES, Paris (FR)

(21) Appl. No.: 19/141,673

(22) PCT Filed: Dec. 18, 2023
(86) PCT No.: PCT/EP2023/086277

§ 371 Date: Jul. 24, 2025

(30) Foreign Application Priority Data
Dec. 21, 2022 (FR) FR2214039

(51) Int. Cl. F16F 3/087; A47C 5/12; A47C 27/14; B33Y 80/00

(52) U.S. Cl. CPC F16F 3/0876; B33Y 80/00; A47C 5/125; A47C 27/14

(57) ABSTRACT

An architectured lattice structure includes a body lattice including a plurality of elementary body patterns that are periodically repeated and are in contact with one another. Each elementary body pattern includes body strands connected to one another to form the apexes of a polyhedron as well as connecting strands connecting the polyhedron at the vertices of the elementary body cell. The structure also includes a surface lattice that defines a face of the structure, at least partially covers the body lattice and includes a plurality of periodically repeated surface elementary patterns. Each surface elementary pattern includes a supporting block that extends parallel to the face of the structure, and deformable feet each including one end that is attached to the supporting block and another end that is attached to one of the connecting strands.

### TECHNICAL FIELD

The present invention relates to the field of architectured lattice structures, in particular for forming devices comprising a flexible interface, for example fleece-lined. These architectured lattice structures can be intended to absorb an impact and/or form a body support, such as a base of a seat, a cushion, a mattress, an armrest, a headrest, a wristrest, a gripping handle, or a helmet padding.

### PRIOR ART

Structures with a lattice architecture have a high level of apparent porosity. They are formed by strands or beams, generally dense, connected to each other in geometric unit patterns that are repeated periodically in space. They can have advantageous mechanical properties in compression, and are in particular capable of withstanding significant deformation without failure or irreversible deformation. They are thus suitable for applications in which the ability to store and/or dissipate energy under compression is important, for example for designing shock absorbers. They are also suitable for applications in which the sensation of user comfort is sought, for example for designing body support elements such as seat bases. cushions, mattresses, armrests, headrests, wristrests, or gripping members, for example handles.

In these applications, structures are in particular sought that have a low shear modulus and/or are capable of absorbing and/or dissipating a large amount of deformation energy before failure, also referred to as high densification per unit of volume.

The mechanical properties in compression of an architectured lattice structure depend on the constituent source material and differ depending on the geometric unit pattern formed by the strands/beams, as well as its dimensional parameters. The article by M. Nasim and U. Galvanetto entitled “Mechanical characterisation of additively manufactured PA12 lattice structures under quasi-static compression”, Materials Today Communications, Volume 29, 2021, 102902, compares the mechanical properties of architectured lattice materials depending on the unit pattern of the strands/beams.

Among various known unit patterns, the rhombic dodecahedron pattern has a low shear modulus and high densification per unit of volume.

FIGS. 1A and 1B show a lattice 1 formed by a plurality of rhombic dodecahedron unit patterns 2 that are repeated periodically and in contact with each other, and FIGS. 2A, 2B, and 2C show a rhombic dodecahedron unit pattern 2. The unit pattern 2 comprises twenty-four strands 3 connected to each other so as to form the edges of a rhombic dodecahedron 4 The rhombic dodecahedron 4 comprises six acute-angled vertices 5 and eight obtuse-angled vertices 6. An acute-angled vertex 5 is a vertex at which four faces of the rhombic dodecahedron meet at their acute angles. An obtuse-angled vertex 6 is a vertex at which three faces of the rhombic dodecahedron meet at their obtuse angles. The unit pattern 2 is inscribed in a unit cell 8, which corresponds to the rectangular parallelepiped circumscribing each of the acute-angled vertices 5. The unit pattern 2 also comprises eight connecting strands 7, each connecting one of the obtuse-angled vertices 6 to the nearest vertex of the unit cell &. The connecting strands 7 extend along the diagonals of the unit cell 8.

The rhombic dodecahedron unit pattern 2 is similar to the pattern known as “fluorite” in the nTopology 3.26.3 software package developed and marketed by nTopology Inc. It is similar to a crystalline structure of fluorite in which each of the atomic sites have been connected to each other by strands.

As illustrated in FIGS. 1A and 1B, the adjacent rhombic dodecahedron unit patterns 2 are fastened to each other by contact between their respective connecting strands 7 and by contact between their respective acute-angled vertices.

Although an architectured lattice structure 1 according to a periodic rhombic dodecahedron unit pattern 2 has satisfactory mechanical properties, in particular for the replacement of certain polyurethane foams, they do however have a small contact surface 9. The contact surface 9 is all of the points of the structure 1 of the surface enveloping an outer face 22 of said structure 1. For the architectured lattice structure 1 in FIGS. 1A and 1B, the contact surface 9 is defined by the ends 7a of the connecting strands 7 and the acute-angled vertices 5 on the outer face 22 of the structure 1. When a solid, for example part of a human body, is placed in contact with the structure 1, the contact force is thus distributed over a small contact area. This results in locally high stresses in contact with the contact surface 9. When a body is supported, the user thus feels a sensation of discomfort, as the free strands and edges act. like a set of points.

There is therefore a need for an architectured lattice structure that overcomes these drawbacks. There is a further need for an architectured lattice structure having a low shear modulus and allowing high densification per unit of volume, the structure having a large contact surface when a body is supported and being, in particular, pleasant to the touch.

### DISCLOSURE OF THE INVENTION

The invention relates to an architectured lattice structure comprising:
a body lattice comprising a plurality of body unit patterns that are repeated periodically and in contact with each other, each body unit pattern comprising body strands connected to each other to form the edges of a polyhedron and connecting strands connecting the polyhedron to the vertices of the body unit cell, which is the smallest rectangular parallelepiped circumscribing the body unit pattern,
a surface lattice defining a face of the structure and at least partially covering the body lattice, the surface lattice comprising a plurality of surface unit patterns that are repeated periodically,
each surface unit pattern comprising a supporting block extending in a mid-plane, parallel to the face of the structure defined by the surface lattice, and deformable feet, each comprising one end fastened to the supporting block and another end fastened to one of the connecting strands and at a distance from the mid-plane,
the surface lattice being configured so that, under the effect of a compressive force normal to the mid-plane, the feet deform in order to translate the supporting block along an axis parallel to the compressive force.

A “unit cell” is the smallest rectangular parallelepiped circumscribing a unit pattern. The unit cell is a fictitious geometric construction, that is, it is not made up of material, unlike the strands and beams.

Advantageously, the surface lattice increases the contact surface of the architectured lattice structure without significantly influencing the mechanical properties in compression thereof, which are mostly determined by the body lattice. The contact surface is formed by the supporting block and can thus be without points. As a result, the contact stress is reduced when a body is supported, and the part is therefore more comfortable for the user.

In addition, when a compressive force is applied to the surface lattice, it transfers this force to the body lattice homogeneously and uniformly. This results in satisfactory distribution of the stresses in the architectured lattice structure as a whole, and therefore improved comfort for the user.

Preferably, the surface unit patterns are in contact with each other.

Preferably, the feet are at least elastically deformable.

Preferably, the feet of each surface unit pattern are unconnected to each other. Advantageously, the surface lattice is then more flexible, that it, it has a lower shear modulus, and, when a compressive force is applied to the surface lattice, it places little stress on the body lattice. Preferably, each foot is formed by a single branch, that is, it does not have multiple branches. A foot that is unconnected to another foot does not have any connection to said other foot over the entire portion thereof between the two ends fastened to the supporting block and to the connecting strand.

Preferably, the feet comprise a straight portion. The cross-section of the straight portion can be ellipsoid, in particular circular, or quadrilateral, in particular rectangular. The cross-section of the straight portion can be continuous, and in particular the straight portion can be cylindrical, or the size and shape of the cross-section can change along the straight portion.

Preferably, each foot is bent at the end thereof fastened to the supporting block Preferably, each foot comprises two straight portions connected to each other by a bend. Preferably, the distance between the end fastened to the supporting block and the bend, measured parallel to the mid-plane, is greater than or equal to 0.5 mm.

The bent shape of the feet prevents undesirable collisions with the body lattice and the supporting block when the feet deform under the effect of the compressive force normal to the mid-plane. When a compressive force is applied to the surface unit patterns, the feet thus transfer the force homogeneously to the body unit patterns.

Preferably, each surface unit pattern comprises four feet.

Preferably, each foot extends along a longitudinal axis forming an angle of between 10 and 70° with the mid-plane.

Preferably, the distance between the end fastened to the supporting block and the end fastened to one of the connecting strands, measured orthogonally to the mid-plane, is between 3 and 50 mm.

Preferably, the distance between the end fastened to the supporting block and the end fastened to one of the connecting strands, measured parallel to the mid-plane, is between 10% and 90% of the size of the longest side, parallel to the mid-plane, of the surface unit cell, which is the smallest rectangular parallelepiped circumscribing the surface unit pattern. Preferably, the distance between the end fastened to the supporting block and the end fastened to one of the connecting strands, measured parallel to the mid-plane, is between 0.5 and 45 mm.

Preferably, the feet the ends fastened to the supporting block of which are proximal to the edge of the surface lattice are shorter than the other feet. Advantageously, this reduces or even eliminates the behavioral singularities under compressive strain on the periphery of the face of the structure defined by the surface lattice. In particular, the body strands and connecting strands on the periphery of the body lattice deform more easily than the other body strands and connecting strands. The shortening of the feet the ends fastened to the supporting block of which are proximal to the edge of the surface lattice makes them stiffer compared to the other feet. The architectured lattice structure thus has a uniform shear modulus over the entire face defined by the surface lattice.

Preferably, each surface unit pattern is inscribed in a surface unit cell in the shape of a rectangular parallelepiped and having a coincident face that shares the same vertices as a face of one of the body unit cells.

Preferably, the coincident face of the surface unit cell has sides of between 5 mm and 50 mm.

Preferably, the coincident face of the surface unit cell is square.

Preferably, the end fastened to the supporting block of each of the feet of a surface unit pattern is at a distance from each of the lateral faces of the surface unit cell. Advantageously, this limits, or even eliminates, the risk of collision between the feet of two adjacent surface unit patterns when a compressive force is applied to said surface unit patterns, Preferably, the distance between the end fastened to the supporting block and the lateral face of the nearest surface unit cell is between 1 mm and 40% of the distance between said nearest lateral face and the lateral face of the surface unit cell opposite said nearest lateral face, in particular between 1 and 20 mm.

The lateral faces of the surface unit cell are the faces perpendicular to the coincident face of the surface unit cell.

Preferably, viewed orthogonally to the mid-plane, the end of each of the feet that is fastened to the supporting block is at a distance from the diagonals of the surface unit cell.

Preferably, the supporting block comprises a reinforcement comprising a plurality of reinforcing beams connected to each other to form the sides of a polygon parallel to the mid-plane. Advantageously, the reinforcement transfers the compressive force uniformly to each of the feet. This uniform transfer ensures that the supporting block is kept parallel to the mid-plane when the feet deform.

Preferably, the end of each foot that is fastened to the supporting block is fastened to the reinforcement. This simplifies the fastening of each foot to the supporting block so as to avoid any collision between the foot and the supporting block when the foot deforms.

The supporting block can consist of the reinforcement.

Preferably, each of the reinforcing beams is at a distance from each of the lateral faces of the surface unit cell. Advantageously, this limits, or even eliminates, the risk of collision between the reinforcements of two adjacent surface unit patterns when a compressive force is applied to said surface unit patterns.

Preferably, the reinforcement has a thickness, measured orthogonally to the mid-plane, of between 0.6 mm and 5 mm, preferably between 0.8 and 3 mm.

Preferably, the reinforcing beams are made from a polymer material or a metal or a composite, for example from a thermoplastic, preferably a thermoplastic elastomer, or from a polymer filled with glass beads.

Preferably, the reinforcement comprises at least four, preferably at least six, reinforcing beams, the polygon preferably being a hexagon, preferably convex and/or irregular.

Preferably, the reinforcement is invariant by at least one rotation about a reinforcement axis normal to the mid-plane, preferably by a rotation of angle π/2. Preferably, the reinforcement axis passes through the center of the body unit cell.

Preferably, the reinforcement is configured to be at a distance from the body strands and the connecting strands when the feet are deformed by the compressive force and the end fastened to the supporting block is contained in the body unit cell Advantageously, the absence of contact between the reinforcement and the body strands and the connecting strands, when the feet are under compressive strain, reduces the influence of the surface lattice on the mechanical properties of the architectured lattice structure, in particular on its densification per unit of volume, In particular, the mechanical behavior of the surface lattice, under the effect of a compressive force normal to the mid-plane, is mostly determined by the deformation of the feet.

Preferably, the reinforcement is configured to be above the connecting points between the connecting strands and the body strands when the feet are deformed by the compressive force.

Preferably, the supporting block covers at least 50% of the face of the surface unit pattern viewed orthogonally to the mid-plane.

Preferably, the supporting block comprises a skin that extends parallel to the mid-plane and covers at least 50% of the face of the surface unit pattern viewed orthogonally to the mid-plane, Advantageously, the skin increases the contact surface of the architectured lattice structure. The skin also prevents contact between the user being supported by the architectured lattice structure and the points of the polyhedrons of the body unit patterns. The skin can also improve the esthetic appearance of the architectured lattice structure. The skin can in particular comprise a visual mark, for example an impression, an imprint and/or a texture. The skins of a plurality of supporting blocks, in particular adjacent, can define a visual pattern, for example a logo. Furthermore, the skin can cover the feet of the surface lattice. It thus protects the feet of the surface lattice by preventing said feet from being pulled out, or by preventing undesirable mechanical stress on said feet.

According to one embodiment, the supporting block can consist of the skin. The feet are then fastened directly to the skin. The thickness of the skin can be adjusted accordingly. The skin can in particular have a greater thickness at the fastening points between the feet and the skin.

Preferably, the skin has a thickness of between 0.6 mm and 2 mm, preferably between 0.8 and 1.5 mm.

Preferably, the distance between the skin and the bend, measured orthogonally to the mid-plane, is between 0.4 and 1 mm.

Preferably, the skin is made from a polymer material or a metal or a composite, for example from a thermoplastic, preferably a thermoplastic elastomer, or from a polymer filled with glass beads.

Preferably, the skin is borne by the reinforcement, preferably fastened to the reinforcement.

The skin of the surface unit pattern can be unconnected to the skins of the other surface unit patterns. The surface lattice then transfers the compressive force to the body lattice in a localized manner. The surface unit patterns undergoing the compressive force transfer it to the adjacent body unit patterns. The influence of the surface unit patterns not undergoing the compressive force on the mechanical behavior of the architectured lattice structure is negligible.

As a variant, the skin of the surface unit pattern comprises attachment points rigidly connecting said skin to the skins of the adjacent surface unit patterns. The transfer of the compressive force from the surface lattice to the body lattice is then better distributed on the surface layer and therefore more homogeneous over the entire structure. The skin is also more robust. In addition, the rigid connection between the skins of the various surface unit patterns limits the risk of individual pull-out of a surface unit pattern. Finally, the connections between the skins of the surface unit patterns increase the contact surface of the architectured lattice structure.

Preferably, the skin is configured to be at a distance from the connecting strands when the feet are deformed by the compressive force and the end fastened to the supporting block is contained in the body unit cell. Advantageously, the absence of contact between the skin and the connecting strands, when the feet are under compressive strain, reduces the influence of the surface lattice on the mechanical properties of the architectured lattice structure, in particular on its densification per unit of volume.

Preferably, the skin comprises at least one notch extending facing one of the connecting strands.

Preferably, the skin has an opening that is aligned orthogonally to the mid-plane at one vertex of the polyhedron. Preferably, the vertex is contained in the face of the body unit cell coincident with the face of the surface unit cell. On the translation of the supporting block under the effect of the compressive force, the vertex of the polyhedron is engaged in the opening, preferably without protruding beyond the face defined by the surface lattice, and then the skin transfers the compressive force to the body strands. It is thus possible to configure the amplitude of the travel in translation of the supporting block before the compressive force is transferred at the vertex of the polyhedron. In addition, due to the opening, the skin does not press on a point when the compressive force is transferred, which limits the risks of tearing or significant deformation of the skin. Furthermore, once it is engaged in the opening and in contact with the skin, the vertex of the polyhedron mechanically prevents the supporting block from rotating about an axis normal to the mid-plane and translating parallel to the mid-plane.

Preferably, the supporting block comprises a supporting frame fastened to the skin and configured to press on the body strands when the feet are deformed by the compressive force. The supporting frame makes it possible for the body lattice to absorb the compressive force beyond a predetermined deformation threshold of the feet. It is possible to configure the amplitude of the travel in translation of the supporting block before the compressive force is transferred from the supporting frame to the body lattice.

Preferably, the supporting frame is configured to be engaged around one of the vertices of the polyhedron when the feet are deformed by the compressive force. Once it is engaged in the supporting frame, the vertex of the polyhedron mechanically prevents the supporting block from rotating about an axis normal to the mid-plane and translating parallel to the mid-plane, Preferably, the vertex of the polyhedron is contained in the face of the body unit cell coincident with the face of the surface unit cell.

Preferably, the distance between the supporting frame and the body lattice, measured orthogonally to the mid-plane, is between 2 mm and 20 mm.

Preferably, the supporting frame has a thickness, measured orthogonally to the mid-plane, of between 0.6 mm and 4 mm.

Preferably, the supporting frame is made from a polymer material or a metal or a composite, for example from a thermoplastic, preferably a thermoplastic elastomer, or from a polymer filled with glass beads.

Preferably, the architectured lattice structure is monolithic, preferably made from a single material.

Preferably, the thickness of the surface lattice, measured orthogonally to the mid-plane is between 4 mm and 50 mm.

Preferably, the body unit cell is cuboid, preferably having sides of between 5 mm and 50 mm.

Preferably, the body unit cell circumscribes the polyhedron.

Preferably, the polyhedron is a rhombic dodecahedron. Preferably, the connecting strands connect the obtuse-angled vertices of the rhombic dodecahedron to the vertices of the body unit cell.

A “thombic dodecahedron” is a convex polyhedron having twelve rhombic faces. It therefore comprises six acute-angled vertices, eight obtuse-angled vertices, and twenty-four edges.

Preferably, the diameter of the body strands and/or the diameter of the connecting strands and/or the diameter of the feet is/are between 0.6 mm and 3 mm, preferably between 0.8 mm and 2 mm.

Preferably, the body strands and/or the connecting strands and/or the feet are made from a polymer material or a metal or a composite, for example from a thermoplastic, preferably a thermoplastic elastomer, or from a polymer filled with glass beads.

The invention also relates to a device selected from:
a shock absorber,
a body support element, for example a base of a seat, a cushion, a mattress, an armrest, a headrest, a helmet padding, or a wristrest, and
a gripping member, for example a gripping handle, or a steering wheel,
the device comprising an architectured lattice structure according to the invention.

Finally, the invention relates to a method for manufacturing an architectured lattice structure according to the invention by means of an additive manufacturing technique.

### BRIEF DESCRIPTION OF THE DRAWINGS

Further advantages and features will become more clearly apparent on reading the detailed description given by way of non-limiting illustration, with reference to the following figures:

FIG. 1A and FIG. 1B are perspective and top views respectively of a lattice comprising a plurality of periodic rhombic dodecahedron unit patterns;

FIG. 2A, FIG. 2B, and FIG. 2C are perspective, top, and front views respectively of a rhombic dodecahedron unit pattern;

FIG. 3 is a perspective view of an example of an architectured lattice structure according to the invention, in which the skins of the supporting blocks of the surface unit patterns are unconnected:

FIG. 4A, FIG. 4B, and FIG. 4C are perspective, bottom, and front views respectively of a surface unit pattern of the architectured lattice structure in FIG. 3;

FIG. 5A and FIG. 5B are perspective and top views respectively of an example of an architectured lattice structure according to the invention, in which the skins of the supporting blocks are not shown;

FIG. 6A, FIG. 7A, and FIG. 8A are top views of examples of architectured lattice structures according to the invention, having different positions of the fastening points between the feet and the reinforcements;

FIG. 6B, FIG. 7B, and FIG. 8B are top views of the architectured lattice structures in FIGS. 6A, 7A, and 8A respectively, in which the skins are shown transparently;

FIG. 9 is a top view of an example of an architectured lattice structure according to the invention in which the feet the ends fastened to the supporting block of which are proximal to the edge of the surface lattice are shorter than the other feet;

FIG. 10 is a front view of a surface unit pattern in which the supporting block consists solely of a reinforcement;

FIG. 11 is a perspective view of an example of an architectured lattice structure according to the invention, in which the skins of the supporting blocks of the surface unit patterns are rigidly connected to each other;

FIG. 12 is a top view of a surface unit pattern fastened to a body unit pattern of the architectured lattice structure in FIG. 11, in which the skin is shown transparently;

FIG. 13A and FIG. 13B are front views of architectured lattice structures according to the invention, each having a different surface lattice thickness;

FIG. 14 is a schematic depiction of an architectured lattice structure according to the invention in which the feet of the surface lattice are completely deformed;

FIG. 15 is a front view containing an enlargement of a portion of an example of an architectured lattice structure according to the invention, in which the supporting frame is pressing on the body strands and the reinforcement is shown transparently;

FIG. 16A, FIG. 16B, and FIG. 16C are perspective, top, and front views respectively of an example of an architectured lattice structure according to the invention;

FIG. 17 is a graph showing the changes in stress as a function of strain during a compression test on architectured lattice structures according to the invention and an architectured lattice structure according to the prior art.

### DETAILED DESCRIPTION

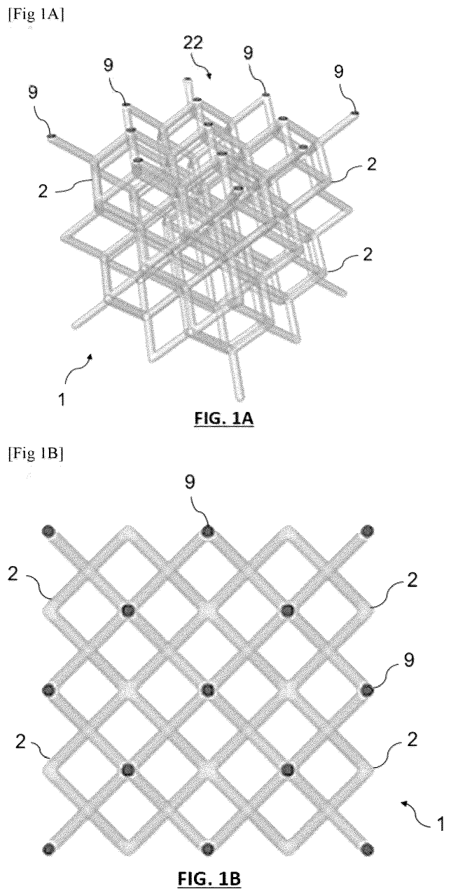

For the sake of clarity, the same reference signs denoting the same elements according to the prior art and according to the invention are used for all of FIGS. 1A to 10.

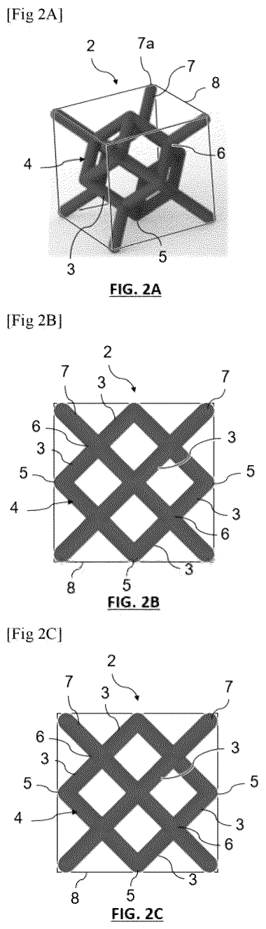

FIGS. 1A to 2C have been described in the description of the prior art.

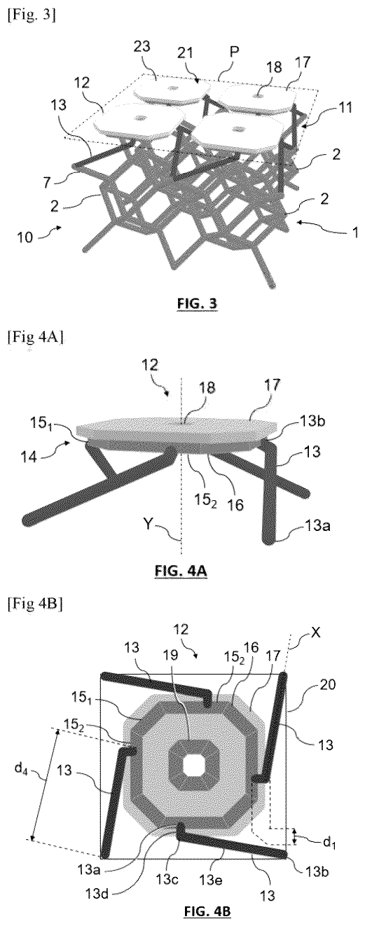

FIG. 3 shows an example of an architectured lattice structure 10 according to the invention. The architectured lattice structure 10 is monolithic and comprises a body lattice 1 and a surface lattice 11 covering the body lattice 1.

The body lattice 1 is similar to the lattice 1 described in the preamble and illustrated in FIGS. 1A and 1B. The body lattice 1 comprises a plurality of body unit patterns 2 that are repeated periodically in space and in contact with each other. The body unit patterns 2 are rhombic dodecahedrons, as described above and illustrated in FIGS. 2A, 2B, and 2C. All of the features already described relating to the lattice 1 and the rhombic dodecahedron unit patterns 2 in FIGS. 1A to 2C are also applicable to the body lattice 1 and the body unit patterns 2.

The surface lattice 11 comprises a plurality of surface unit patterns 12 that are repeated periodically in a plane P and in contact with each other. The surface unit patterns 12 are also in contact with and connected to the body lattice 1.

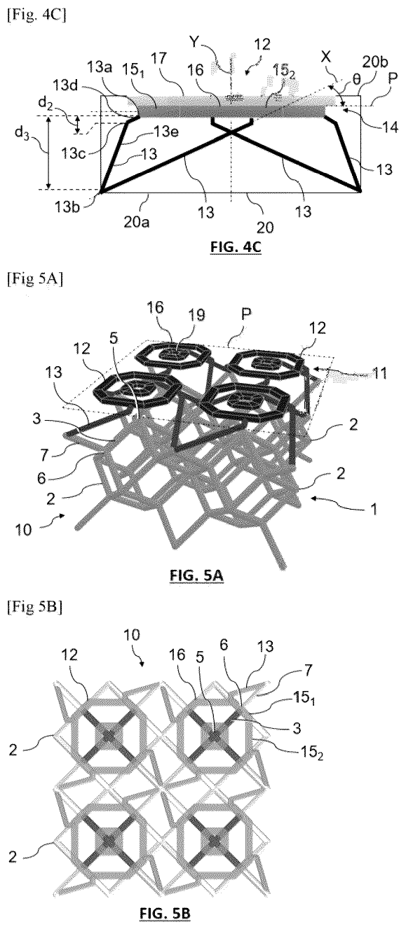

FIGS. 4A to 4C show a surface unit pattern 12 of the surface lattice 11 in FIG. 3. Such a surface unit pattern 12 comprises four feet 13 and a supporting block 14.

Each of the feet 13 consists of a single branch comprising an end 13a fastened to the supporting block 14. The single branch of the foot 13 also comprises another end 13b, opposite the end 13a and fastened to one of the connecting strands 7 of the body lattice 1, as illustrated in FIGS. 4A and 4B.

Between the end 13a and the other end 13b, the foot 13 comprises a bend 13c near the other end 13b. The bend 13c thus divides the single branch of the foot 13 into a first straight portion 13d connecting the end 13a to the bend 13c and a second straight portion 13e connecting the other end 13b to the bend 13c.

Each foot 13 is characterized by distances d₁ and d₂, measured parallel and orthogonally to the plane P respectively, between the end 13a and the bend 13c. These distances d₁ and d₂ are selected such that the foot 13 remains at a distance from the supporting block 14 and the body lattice 1 when the end 13a deforms in bending and/or twists.

Each foot 13 extends along a longitudinal axis X. The longitudinal axis X forms an angle θ with the plane P. Each foot 13 is further characterized by distances d₃ and d₄, measured orthogonally and parallel to the plane P respectively, between the end 13a and the other end 13b. The angle θ, the distance d₃, and the distance d₄ are each selected as a function of the desired deformation behavior under the effect of a compressive force normal to the plane P applied to the supporting block 14.

The angle θ and the distance d₄ influence in particular the stiffness of the foot 13. The smaller the angle θ and/or the greater the distance d₄, the more flexible the foot 13, that is, the more easily it bends. Preferably, the angle θ and the distance d₄ are selected such that the surface lattice 11 has a shear modulus less than or equal to the shear modulus of the body lattice 1.

The distance d₃ influences in particular the amplitude of the travel in translation of the supporting block 14 along an axis parallel to the compressive force. The greater the distance d₃, the greater said amplitude. The distance d₃ is the same for each of the feet 13 such that the supporting block 14 remains parallel to the mid-plane P under the effect of a compressive force normal to the mid-plane.

The supporting block 14 extends in the plane P, referred to as the mid-plane P. The supporting block 14 comprises a set of reinforcing beams 15₁, 15₂ connected to each other, forming a reinforcement 16. The supporting block 14 also comprises a skin 17 borne by and fastened to the reinforcement 16.

The reinforcement 16 is parallel to the mid-plane P. It is in the shape of a convex, irregular hexagon. In particular, the reinforcing beams 15₁ nearest to the ends 13b are shorter than the other reinforcing beams 15₂. In addition, the ends 13a are fastened to said longer other reinforcing beams 15₂.

The reinforcement 16 is centered around a reinforcement axis Y normal to the mid-plane P. The reinforcement is invariant by rotation of angle π/2 about the reinforcement axis Y. Likewise, the feet 13 are invariant by rotation of angle π/2 about the reinforcement axis Y.

As illustrated in FIGS. 5A and 5B, in which the architectured lattice structure 10 in FIG. 3 is shown without the skin 17, the reinforcement 16 of a surface unit pattern 12 has shape that complements the body unit pattern 2 to which the feet 13 of the surface unit pattern 12 are fastened. Viewed orthogonally to the mid-plane P, the reinforcement 16 surrounds the body strands 3 forming the vertex 5 of the rhombic dodecahedron 4 nearest to said reinforcement 16. In addition, viewed orthogonally to the mid-plane P, the connecting strands 7 are outside the reinforcement 16. In particular, viewed orthogonally to the mid-plane P, the reinforcing beams 15, are above the connecting points 6 between the connecting strands 7 and the body strands 3. Starting from the reinforcement 16 and following a normal to the mid-plane P, the points of the body unit pattern 2 nearest the reinforcement 16 are the connecting points 6. The distance between the reinforcement 16 and the body unit pattern 2, measured orthogonally to the mid-plane P, is thus maximized. When the feet 13 are deformed by a compressive force with the end 13a arranged in the body unit cell 8, the reinforcement 16 thus remains at a distance from the body strands 3 and the connecting strands 7.

The fastening point between the end 13a and the reinforcing beam 15₂ can vary along the entire length of the reinforcing beam 15₂. FIGS. 6A, 6B, 7A, 7B, 5A, and SB show embodiments of an architectured lattice structure 10 having different positions of the fastening point between the end 13a and the reinforcing beam 15₂.

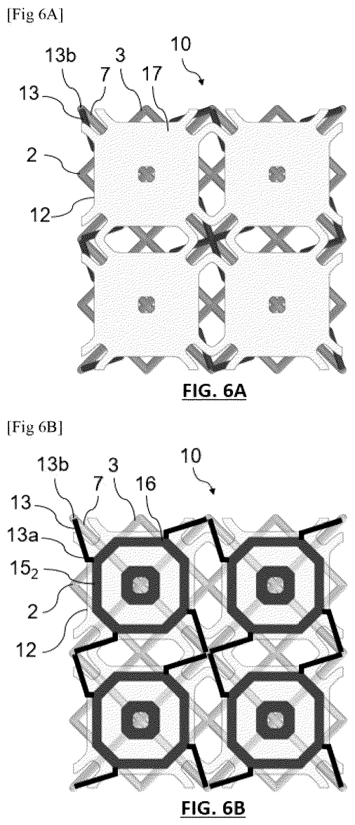

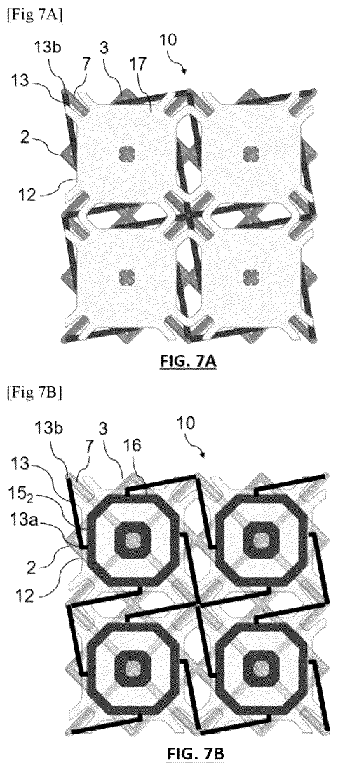

In the example illustrated by FIGS. 6A and 6B, the end 13a of each of the feet 13 is fastened to the point of the reinforcing beam 15₂ nearest to the end 13b of the corresponding foot 13.

In the example illustrated by FIGS. 7A and 7B, the end 13a of each of the feet 13 is fastened to a point of the reinforcing beam 15₂ nearest to the middle thereof.

In the example illustrated by FIGS. 8A and 8B, the end 13a of each of the feet 13 is fastened to the point of the reinforcing beam 15₂ furthest from the end 13b of the corresponding foot 13.

Varying the position of the fastening point between the end 13a and the reinforcing beam 15₂ along the length of said reinforcing beam 15₂, causes the angle θ and the distance d₄ to vary. It is thus possible to modify the stiffness of the foot 13 while retaining the same distance d₃. For example, the feet 13 in the embodiment in FIGS. 6A and 6B are stiffer than the feet 13 in the embodiment in FIGS. 7A and 7B, which are stiffer than the feet 13 in the embodiment in FIGS. 8A and 8B.

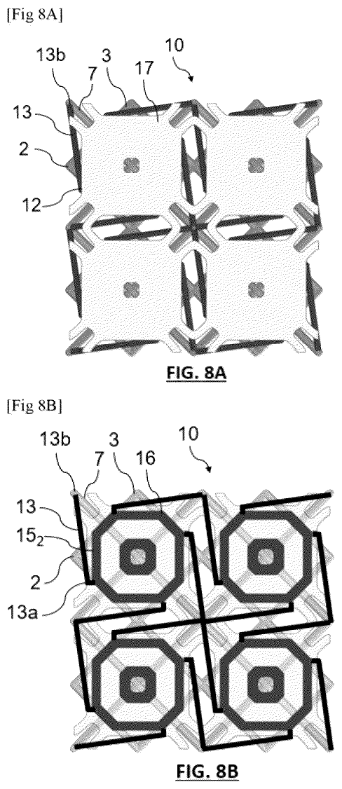

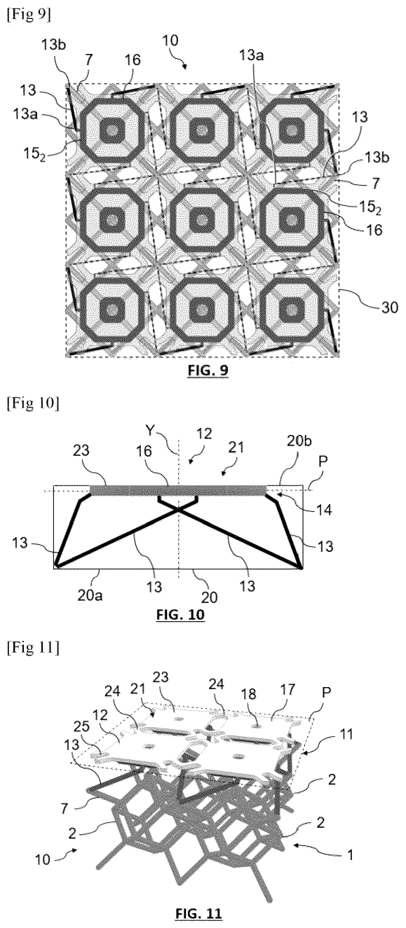

Furthermore, for a single surface unit pattern 12, at least one of the feet 13 can have an angle θ and a distance d₃ that are different from the other feet 13. For example, FIG. 9 shows an architectured lattice structure 10 according to the invention in which the feet 13 the ends 13a fastened to the supporting block of which are proximal to the edge 30 of the surface lattice 11 have a larger angle θ and a greater distance d₃ than the other feet 13. In particular, the ends 13a proximal to the edge 30 of the surface lattice 11 are each fastened to the point in the middle of the corresponding reinforcing beam 15₂. The ends 13a that are not proximal to the edge 30 of the surface lattice Il are each fastened to the point of the corresponding reinforcing beam 15₂ furthest from the end 13b of the corresponding foot 13.

In the embodiment illustrated in FIG. 3, the skin 17 of each of the surface unit patterns 12 is unconnected to the skins 17 of the adjacent surface unit patterns. Viewed orthogonally, the skin 17 has an outer perimeter in the shape of a convex, irregular hexagon. In particular, the shape of the outer perimeter of the skin 17 is an enlargement of the outer perimeter of the reinforcement 16. The skin 17 is thus configured to be at a distance from the connecting strands 7 when the feet 13 are deformed by the compressive force and the end 13a is contained in the body unit cell 8.

The skin 17 comprises a central opening 18. The central opening 18 is facing, that is aligned orthogonally to the mid-plane P, the vertex 5 of the rhombic dodecahedron 4 nearest to the skin 17. The central opening 18 is in the shape of a convex, irregular hexagon. In particular, the outer perimeter of the central opening 18 is a reduction of the inner perimeter of the reinforcement 16.

The surface unit pattern 12 of the surface lattice 11 also comprises a supporting frame 19 fastened to the skin 17 as illustrated in FIG. 4B. The supporting frame 19 is arranged between the skin 17 and the body unit pattern 2 to which the feet 13 are fastened. The supporting frame 19 extends in the mid-plane P around the central opening 18. The supporting frame 19 is a convex, irregular hexagon. In particular, the supporting frame 19 has an aperture superposed on the central opening 18 and having an identical shape to this central opening for example. The supporting frame 19 is thus aligned orthogonally to the mid-plane P with the body strands 3 forming the vertex 5 of the rhombic dodecahedron 4 nearest to the skin 17. When the feet 13 deform under the effect of a compressive force normal to the mid-plane P, the supporting frame 19 comes into contact with and presses on the body strands 3 forming the vertex 5 of the rhombic dodecahedron 4 nearest to the skin 17. The supporting frame 19 then transfers some of the compressive force to the body lattice 1. Furthermore, the supporting frame 19 stiffens the skin 17 at the opening 18, and thereby reduces the risk of tearing of the skin 17.

The surface unit pattern 12 is inscribed in a surface unit cell 20, which corresponds to the smallest rectangular parallelepiped circumscribing the surface unit pattern 12. Each surface unit cell 20 comprises a face 20a comprising an end 13b of a foot 13 at each of its vertices. The face 20a is coincident with one of the faces of the body unit cell 8, sharing the same vertices. Viewed orthogonally to the mid-plane P, the feet 13 converge spirally towards the inside of the surface unit cell 20, starting from the ends 13b and moving towards the ends 13a.

The surface unit patterns 12 define an outer face 21 of the structure 10. This outer face 21 is parallel to the plane P. The surface lattice 11 has a contact surface 23 defined as all of the points of the surface lattice 11 contained in a single plane of the outer face 21. The contact surface 23 is formed by the surface of the skin 17 contained in the face 20b of the surface unit cell 20 opposite the face 20a. The contact surface 23 of the surface lattice 11 is thus larger than the contact surface 9 of the body lattice 1. In addition, the contact surface 23 of the surface lattice 11 does not have any points. The sensation of comfort for a user supported on an architectured lattice structure 10 comprising a body lattice 1 and the surface lattice 11 covering the body lattice 1 is thus improved.

FIG. 10 illustrates another example in which the supporting block 14 consists solely of the reinforcement 16. The contact surface 23 is the surface of the reinforcement 16 contained in the face 20b of the surface unit cell 20 opposite the face 20a. The contact surface 23 of the surface lattice 11 is larger than the contact surface 9 of the body lattice 1. In addition, the contact surface 23 of the surface lattice 11 does not have any points. The sensation of comfort for a user supported on an architectured lattice structure 10 comprise a body lattice 1 and the surface lattice 11 covering the body lattice 1 is thus improved.

FIG. 11 shows another example of an architectured lattice structure 10 according to the invention. The architectured lattice structure 10 in FIG. 11 differs from that in FIG. 3 in that the skins 17 of the various surface unit patterns 12 are rigidly connected to each other. The skin 17 of each surface unit pattern 12 comprises attachment points 24 rigidly connected to the attachment points 24 of the adjacent skins 17. The attachment points 24 are situated near the vertices of the face 20b of the surface unit cell 20. Furthermore, each skin 17 comprises notches 25 extending facing one of the connecting strands 7, as illustrated in FIG. 12. When the supporting block 14 translates orthogonally to the mid-plane P, the connecting strands 7 thus engage in the notches 25 and do not come into contact with the skin 17.

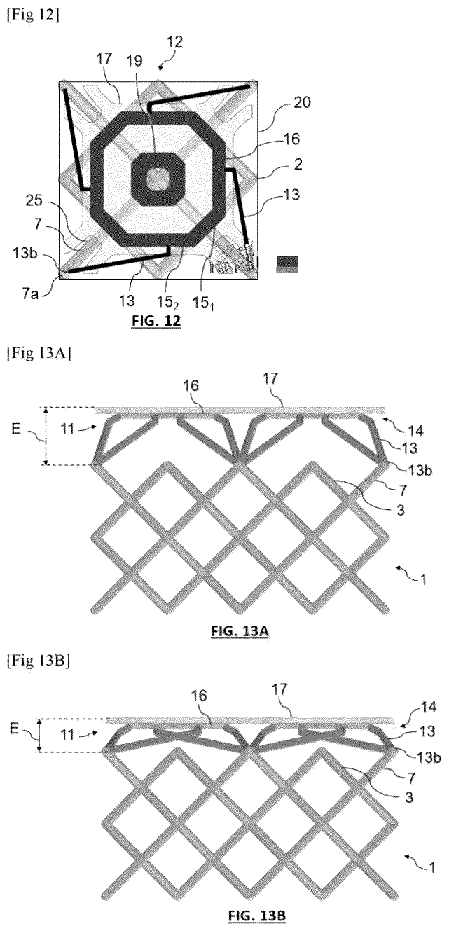

FIGS. 13A, 13B show architectured lattice structures 10 according to the invention. The architectured lattice structure 10 in FIG. 13A comprises a surface lattice 11 the thickness E of which is greater than that of the surface lattice 11 of the architectured lattice structure 10 in FIG. 13B. The amplitude of travel in translation of the supporting block 14 of the surface lattice 11 in FIG. 13A is thus greater than the amplitude of travel in translation of the supporting block 14 of the surface lattice 11 in FIG. 13B.

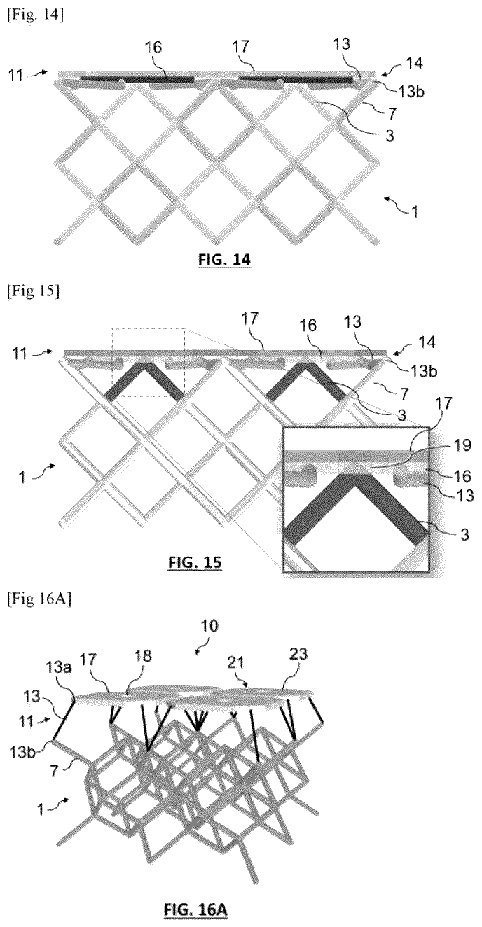

FIG. 14 shows an architectured lattice structure 10 according to the invention deformed under the effect of a compressive force. The surface lattice 11 undergoes a compressive force normal to the mid-plane P that is sufficient to completely deform the feet 13, that is, the feet 13 will not deform further without breaking under an additional compressive force. The supporting block 14 is then in contact with the body lattice 1. All of the forces beyond the threshold at which the feet 13 are completely deformed are transferred to the body lattice 1. The compressive force is transferred from the surface lattice 11 to the body lattice I by the feet 13 and by the supporting block 14, in particular the supporting frame 19 in contact with the body strands 3, as illustrated in FIG. 15.

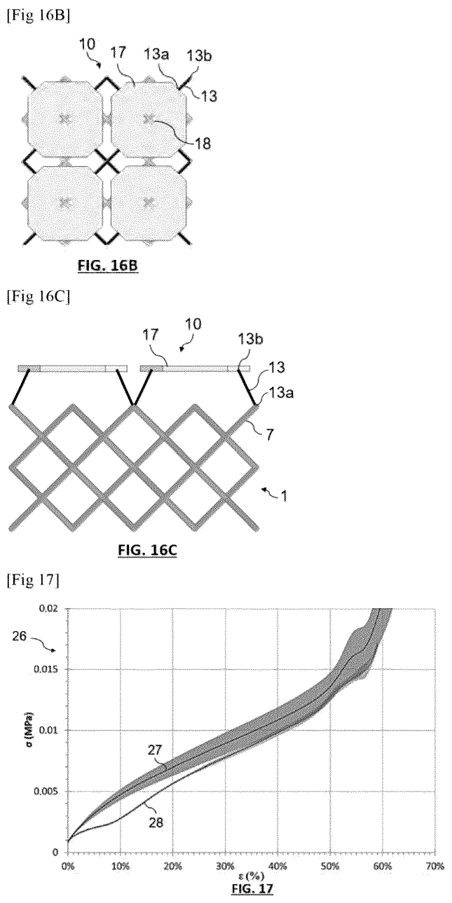

FIGS. 16A, 16B, and 16C show another architectured lattice structure 10 according to the invention. The architectured lattice structure 10 in FIGS. 16A to 16C differs from that in FIG. 3 in that the feet 13 are formed by a single straight portion and the supporting block 14 consists solely of the skin 17. The feet 13 do not therefore have a bend 13c. The end 13a of each foot 13 is fastened directly to the outer perimeter of the skin 17, particularly at the point of the skin 17 nearest to the other end 13b of the foot 13.

The inventors have performed comparison compression tests on architectured lattice structures 10 similar to the one illustrated in FIG. 3 and control architectured lattice structures consisting solely of a body lattice 1. The body unit patterns 2 of the control architectured lattice structures are identical to the body unit patterns 2 of the body lattice 1 of the architectured lattice structure 10 illustrated in FIG. 3. For each of the architectured lattice structures tested, the body unit cells & are cubes with 15 mm sides, the body strands 3 and the connecting strands 7 have a diameter of 1.0 mm, the body lattice 1 is made up of three square strata one above the other and each comprising five rows of five aligned body unit patterns 2. For each of the architectured lattice structures 10 according to the invention tested, the feet 13 have a diameter of 1.0 mm.

The compression tests were performed in a direction normal to the plane P in which the surface lattice 11 extends. For each of the architectured lattice structures 10 tested, the compression test consists in applying a preload of 2 N followed by four compressions at a speed of travel along an axis parallel to the reinforcement axes Y of 5 mm/min to a deformation of 70%, then a fifth compression at a speed of 1 mm/min.

FIG. 17 shows the results of the fifth compressions in the form of a stress-strain graph 26. The graph 26 comprises a curve 27 of the mean stress-strain value of the compression tests on three samples with control architectured lattice structures produced by the same 3D printing process. The graph 26 also comprises a curve 28 of the mean stress-strain value of the compression tests on three examples of architectured lattice structures 10 according to the invention produced by the same 3D printing process.

As can be seen in the graph 26, for deformations of less than 16%, the stress for the strain in compression of the structures 10 according to the invention is less than the stress for the strain in compression of the control structures. This is shown by the difference in stress, at a fixed strain, between the curve 27 and the curve 28. In other words, for these small deformations, the structures 10 according to the invention are more flexible than the control structures. Beyond 16% deformation, the presence of a surface lattice does not appear to influence the mechanical properties of the architectured lattice structure 10. The presence of a surface lattice 11 on the body lattice 1 of the architectured lattice structure 10 according to the invention thus provides improved comfort for the user supported on said structure 10.

Other variants and improvements can obviously be envisaged without departing from the scope of the invention as defined by the claims below. In particular, although the invention has been described with respect to a body lattice comprising a plurality of rhombic dodecahedron body unit patterns, it is suitable for other types of body unit pattern,

1-19. (canceled)

20. An architectured lattice structure, comprising:
a body lattice comprising a plurality of body unit patterns that are repeated periodically and in contact with each other, each body unit pattern comprising body strands connected to each other to form the edges of a polyhedron and connecting strands connecting the polyhedron to the vertices of the body unit cell, which is the smallest rectangular parallelepiped circumscribing the body unit pattern,
a surface lattice defining a face of the structure and at least partially covering the body lattice, the surface lattice comprising a plurality of surface unit patterns that are repeated periodically,
each surface unit pattern comprising a supporting block extending in a mid-plane, parallel to the face of the structure defined by the surface lattice, and deformable feet, each comprising one end fastened to the supporting block and another end fastened to one of the connecting strands and at a distance from the mid-plane,
the surface lattice being configured so that, under the effect of a compressive force normal to the mid-plane, the feet deform in order to translate the supporting block along an axis parallel to the compressive force.

21. The structure as claimed in claim 20, wherein the feet of each surface unit pattern are unconnected to each other and each foot is formed by a single branch.

22. The structure as claimed in claim 20, wherein each foot is bent at the end thereof fastened to the supporting block, each foot comprises two straight portions connected to each other by a bend, and the distance between the end fastened to the supporting block and the bend, measured parallel to the mid-plane, is greater than or equal to 0.5 mm.

23. The structure as claimed in claim 20, wherein each surface unit pattern comprises four feet.

24. The structure as claimed in claim 20, wherein each foot extends along a longitudinal axis forming an angle of between 10 and 70° with the mid-plane.

25. The structure as claimed in claim 20, wherein the distance between the end fastened to the supporting block and the end fastened to one of the connecting strands. measured orthogonally to the mid-plane, is between 3 and 50 mm.

26. The structure as claimed in claim 20, wherein the distance between the end fastened to the supporting block and the end fastened to one of the connecting strands, measured parallel to the mid-plane, is between 0.5 and 45 mm.

27. The structure as claimed in claim 20, wherein each surface unit pattern is inscribed in a surface unit cell in the shape of a rectangular parallelepiped and having a coincident face that shares the same vertices as a face of one of the body unit cells.

28. The structure as claimed in claim 20, wherein the supporting block comprises a reinforcement comprising a plurality of reinforcing beams connected to each other to form the sides of a polygon parallel to the mid-plane, and the end of each foot fastened to the supporting block is fastened to the reinforcement.

29. The structure as claimed in claim 28, wherein the reinforcement is configured to be at a distance from the body strands and the connecting strands when the feet are deformed by the compressive force and the end fastened to the supporting block is contained in the body unit cell.

30. The structure as claimed in claim 20, wherein the supporting block covers at least 50% of the face of the surface unit pattern viewed orthogonally to the mid-plane, and the supporting block comprises a skin extending parallel to the mid-plane and covering at least 50% of the face of the surface unit pattern viewed orthogonally to the mid-plane.

31. The structure as claimed in claim 30, wherein the supporting block comprises a supporting frame fastened to the skin and configured to press on the body strands when the feet are deformed by the compressive force.

32. The structure as claimed in claim 20, wherein the architectured lattice structure is monolithic and made from a single material.

33. The structure as claimed in claim 20, wherein the thickness of the surface lattice, measured orthogonally to the mid-plane, is between 4 mm and 50 mm.

34. The structure as claimed in claim 20, wherein the polyhedron is a rhombic dodecahedron and the connecting strands connect the obtuse-angled vertices of the rhombic dodecahedron to the vertices of the body unit cell.

35. The structure as claimed in claim 20, wherein the diameter of the body strands and/or the diameter of the connecting strands and/or the diameter of the feet is/are between 0.6 mm and 3 mm.

36. The structure as claimed in claim 20, wherein the body strands and/or the connecting strands and/or the feet are made from a polymer material or a metal or a composite or from a polymer filled with glass beads.

37. A device, comprising:
the structure as claimed in claim 20,
wherein the device is a shock absorber, a body support element, a gripping handle, or a steering wheel.

38. The device according to claim 37, wherein the device is the body support element and the body support element is a seat base, a cushion, a mattress, an armrest, a headrest, a helmet padding, or a wristrest.

39. A method for manufacturing the structure as claimed in claim 20, comprising an additive manufacturing technique.
